(19) United States
(12) Patent Application Publication
(10) Pub. No.: US 2023/0261284 A1
(43) Pub. Date: Aug. 17, 2023

(54) BATTERY PACK, ELECTRIC VEHICLE AND METHOD FOR ASSEMBLING A BATTERY PACK

(71) Applicant: SAMSUNG SDI CO., LTD., Yongin-si (KR)

(72) Inventors: Matthias Pucher, Ragnitz (AT); Michael Erhart, Seiersberg-Pirka (AT); Bernhard Hadler, Feldkirchen/Graz (AT)

(21) Appl. No.: 18/168,481

(22) Filed: Feb. 13, 2023

(30) Foreign Application Priority Data
Feb. 14, 2022 (EP) 22156550.0
Feb. 13, 2023 (KR) 10-2023-0018710

(51) Int. Cl. H01M 10/6566; H01M 50/342; H01M 50/581; H01M 50/204

(52) U.S. Cl. CPC H01M 10/6566; H01M 50/3425; H01M 50/581; H01M 50/204; H01M 2200/10

(57) ABSTRACT

A battery pack includes: a battery housing including a plurality of crossbeams dividing an interior space of the battery housing into a plurality of separated accommodation chambers; a plurality of cell units arranged within the battery housing, each of the cell units including a plurality of stacked battery cells, each of the accommodation chambers accommodating at least two of the cell units separated by a spacer stacked between the at least two cell units; and a plurality of venting paths respectively arranged per each of the cell units, each of the venting paths connecting the respective cell unit with a respective venting device of the corresponding accommodation chamber without passing an adjacent one of the cell units.

### CROSS-REFERENCE TO RELATED APPLICATION

This application claims priority to and the benefit of European Patent Application No. 22156550.0, filed in the European Patent Office on Feb. 14, 2022, and Korean Patent Application No. 10-2023-0018710, filed in the Korean Intellectual Property Office on Feb. 13, 2023, the entire content of both of which are incorporated herein by reference.

### BACKGROUND

### 1. Field

Aspects of embodiments of the present disclosure relate to a battery pack, an electric vehicle, and a method for assembling a battery pack.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

In case of an abnormal operation state, a battery pack is usually disconnected from a load connected to a terminal of the battery pack. Therefore, battery systems may further include a battery disconnect unit (BDU) that is electrically connected between the battery module and battery system terminals. The BDU is the primary interface between the battery pack and the electrical system of the vehicle. The BDU includes electromechanical switches that open or close high current paths between the battery pack and the electrical system.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

Typical battery system layouts have a plurality of single battery cells, which are arranged together in a number of cell stacks (also called cell-modules) to achieve an easier and more efficient handling of stacked cells. Independent of the mechanical concept, an appropriate number of cell stacks is installed in a package-efficient orientation into a given space, which is defined by the structure of the battery housing. Multiple crossbeams and longitudinal beams are provided between the cell stacks to achieve a rigid mechanical structure. The crossbeams and/or longitudinal beams may be, for example, extruded profiles made from aluminum or steel-sheet metal parts. In a casted housing, the crossbeams and longitudinal beams may be structural ribs or casted beams. The electrical connection between the cells is typically realized by using current collector structures, such as busbars, and the high voltage path (HV-path) can be disconnected from the battery cells by relays, which are arranged in the so-called Battery-Junction-Box (or BJB).

In the event of a thermal runaway, a related art safety concept includes moving (or flowing) a hot venting gas from one or more battery cells that are in a thermal runaway condition unguided through the battery pack housing and releasing the gas through a venting device into the environment of the battery pack. Furthermore, in case of a thermal runaway, there is a potential risk of an electric arc between the HV-path, the energized parts, and all other electric conductive parts that are connected to ground potential. This phenomenon primarily requires two conditions. First, because the venting gas includes metallic parts (or particles) of the battery cell and graphite, once the stream of venting-gas passes through the battery pack, a considerable fraction of the battery is contaminated with electric conductive deposits. Second, a voltage in an area is required for an electric arc.

### SUMMARY

The present disclosure is defined by the appended claims and their equivalents. Any disclosure lying outside the scope of the claims and their equivalents is intended for illustrative as well as comparative purposes.

According to one embodiment of the present disclosure, a battery pack includes: a battery housing comprising a plurality of crossbeams dividing an interior space of the battery housing into a plurality of separated accommodation chambers; a plurality of cell units arranged within the battery housing, each of the cell units including a plurality of stacked battery cells, each of the accommodation chambers accommodating at least two of the cell units separated by a spacer stacked between the at least two cell units; and at least one venting path per cell unit. Each of the venting paths connects the respective cell unit with a respective venting device of the corresponding accommodation chamber without passing an adjacent one of the cell units.

According to another embodiment of the present disclosure, an electric vehicle includes the battery pack as described above.

Yet another embodiment of the present disclosure provides a method for assembling a battery pack. The method includes: a) providing a battery housing forming an interior space and comprising a plurality of crossbeams, a plurality of cell units, a plurality of spacers, and a plurality of venting devices; b) arranging the plurality of crossbeams to divide the interior space of the battery housing into a plurality of separated accommodation chambers; and c) arranging the plurality of cell units, the spacers, and the venting devices within the battery housing. Each of the cell units includes a plurality of stacked battery cells, and each of the accommodation chambers accommodates at least two of the cell units separated by the spacer stacked therebetween. The plurality of crossbeams and the plurality of cell units are arranged such that at least one venting path is provided per cell unit, and each venting path connects the respective cell unit with a respective venting device of the corresponding accommodation chamber without passing an adjacent one of the cell units.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic view of a vehicle according to an embodiment.

FIG. 2 is a perspective view of a battery pack according to an embodiment.

FIG. 3 is a first sectional view of a battery pack according to an embodiment.

FIG. 4 is a second sectional view of a battery pack according to an embodiment.

FIG. 5 is a perspective view of a spacer of a battery pack according to an embodiment.

FIG. 6 is a schematic top view of a battery pack according to an embodiment.

FIG. 7 is a schematic top view of a battery pack according to another embodiment.

### DETAILED DESCRIPTION

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

According to one embodiment of the present disclosure, a battery pack includes a battery housing providing an interior space and including a plurality of crossbeams dividing the interior space of the battery housing into a plurality of separated accommodation chambers. For example, any two adjacent accommodation chambers are separated from each other by one of the crossbeams.

The battery pack further includes a plurality of cell units arranged within the battery housing, and each of the cell units includes a plurality of stacked battery cells. The cell units are arranged in the accommodation chambers to arrange and retain the cell units within the battery pack. Thus, a subset of the plurality of cell units is separated from another subset of the plurality of cell units by at least one of the crossbeams.

Each of the accommodation chambers accommodates at least two of the cell units, which are themselves separated by at least one spacer stacked therebetween. For example, the battery pack includes at least one spacer per accommodation chamber. At least two of the cell units are stacked with one of the spacers therebetween. In some embodiments, the at least two cell units and the spacer therebetween form a cell stack, which can be efficiently accommodated within one of the accommodation chambers. Thus, a cell stack includes at least two cell units and at least one spacer, and the at least two cell units and the at least one spacer are alternatingly stacked.

The battery pack further includes at least one venting path per cell unit, and each venting path connects the respective cell unit with a respective venting device of the corresponding accommodation chamber without passing an adjacent cell unit. The at least one venting path of the cell unit is arranged to allow fluid communication of a venting gas from at least one of the battery cells of the respective cell unit with the respective venting device. The spacer of one of the cell stacks in one of the accommodation chambers is arranged so that the venting path does not pass an adjacent cell unit within the accommodation chamber. The crossbeams ensure that a venting gas cannot pass from one of the accommodation chambers to another of the accommodation chambers. Thus, the venting path is geometrically constrained by the at least one spacer per cell stack and the crossbeams.

From structural point of view, the crossbeams provide separation between the accommodation chambers and the cell stacks retained therein. Due to that separation, neighboring rows of cell stacks may be efficiently protected against hot vent gases. Furthermore, due to the separation by the crossbeams, the vent-gas can be efficiently guided to an appropriate venting device. Each cell unit has its own interface, for example, its own venting path to a venting device. This spatial separation of the cell units by the spacers and the crossbeams and of cell stacks by the crossbeams lowers the risk of a total destruction of the battery pack. Depending on the arrangement and orientation of the cell units, a proper layout of a high voltage path minimizes of the risk of arcing.

The spacer being stacked between the cell units instead of being a part of the battery housing allows a single compression device to compress the entire cell stack including at least two cell units and the at least one spacer instead of requiring one compression device for each cell unit and a separate step of assembling the cell units and the spacer. This improves the manufacturability of the battery pack.

According to one embodiment, the cell units are connected between a positive battery pack terminal and a negative battery pack terminal such that the cell units are electrically connected in a series connection. The series connection includes at least two partial series connections, each connecting a number of cell units (e.g., more than one cell unit) in series. The combination of spatial separated rows of cell stacks and/or of cell units by the spacer and an application specific high voltage path routing with the two partial series connection increases the safety performance and cost-efficiency. Thus, the partial series connections are configured to lead to a voltage level to prevent arcing inside the battery.

According to another embodiment, the battery pack includes at least one disconnecting member selectively interconnecting the at least two partial series connections. The series connection is divided into the at least two partial series connections by a selectively electrically conducting disconnection member. Thus, the series connection may be split with a certain voltage into the partial series connections having voltages that are smaller than the voltage of the entire series connection. Thus, only a relatively few disconnection devices in the high voltage path are required, which can be triggered once a thermal event occurs to break down (or reduce) the total voltage of the defective cell stack into smaller units so that the risk of arcing is reliably reduced. In some embodiments, the disconnection member is arranged in one of the spacers to achieve an efficient separation of the partial series connections.

According to another embodiment, the battery pack is configured to open the disconnecting member in the event of a thermal runaway, a short between the positive battery pack terminal and the negative battery pack terminal, and/or an accident of a vehicle including the battery pack. Each of the above-mentioned criteria can lead to a thermal event and/or to arcing and can present a severe safety issue. Embodiments of the preset disclosure provide a battery pack with increased safety performance. In some embodiment, a battery disconnect unit (BDU) and/or a battery management module (BMM) of the battery pack triggers (or outputs) a disconnect signal that is transmitted to the disconnecting members to open the disconnecting member, that is, to control the disconnection member to transition from an electrically conducting state into an electrically isolating state.

According to another embodiment, cell units of each partial series connection are arranged in different accommodation chambers. In other words, the accommodation chamber includes cell units that are not connected via the same partial series connection. This ensures the cell units within the same accommodation chamber as the cell units within the same accommodation chamber are not connected via the same partial series connection. Thus, a thermal event in a cell unit of one the partial series connections and in one of accommodation chamber does not influence another cell unit within the same accommodation chamber because it is connected to different partial series connections and is also does not influence another cell unit within an adjacent accommodation chamber due to the physical separation by one of the crossbeams.

According to another embodiment, the battery pack includes a vent gas guide configured to direct vent gas of one of the cell units to the respective venting device. This ensures that the vent gas is guided from the battery cell at where a thermal event occurs to the venting device. The vent gas guide may include portions of the crossbeams to achieve an efficient construction and/or gas guide portions that are separate from the crossbeams to enable a variable arrangement of the vent gas guide.

According to another embodiment, each of the accommodation chambers includes at least one venting device per cell unit to allow efficient transport (or venting) of vent gas to the venting devices.

According to another embodiment, each venting device includes a burst membrane configured to burst when a pressure within one of the accommodation chambers exceeds a reference (or predetermined) pressure and to efficiently seal the battery pack if no thermal event occurs and to release vent gas if necessary.

According to another embodiment, the battery cells of each of the cell units are electrically connected in series to provide a voltage within each of the cell units.

According to another embodiment, the venting paths of two adjacent cell units within the same accommodation chamber extend through the spacer stacked between the two adjacent cell units. In some embodiments, a bottom cover of the battery housing, a top cover of the battery housing, and/or the spacer may include the venting device and a terminal of the vent gas guide. This allows for an efficient arrangement of the venting paths and a well-defined release of vent gas, if necessary.

According to another embodiment, a lateral extension of each of the crossbeams matches (e.g., defines or is the same or substantially the same as) a lateral extension of the battery housing. For example, the height of the crossbeams extends from a bottom of the housing to a top of the housing. In other words, each of the crossbeams extends from a bottom cover to a top cover. Thus, the crossbeams provide separation between the cell stacks to efficiently prevent a vent gas from flowing from one accommodation chamber to another accommodation chamber. Thus, a sealing member can be omitted.

According to another embodiment, the housing includes an interior separation member providing a collecting chamber within the housing, and each venting path is arranged to extend into the collecting chamber. This embodiment enables the vent gas to be efficiently collected in the collecting chamber. The interior separation member can be arranged between the cell stacks and a top cover of the battery housing and/or between the cell stacks and a bottom cover of the battery housing. The collecting chamber is arranged between the interior separation member and the top cover and/or the bottom cover, respectively.

According to another embodiment, the housing includes a duct member for fluid communication between the collecting chamber and an exterior of the battery pack. This allows for a well-defined release of vent gas that has been collected in the collecting chamber out of the battery pack.

According to another embodiment of the present disclosure, an electric vehicle includes the battery pack according to an embodiment of the present disclosure. The battery pack of the electric vehicle may include any of the aforementioned features in any suitable combination to achieve the aspects and features associated therewith.

Yet another embodiment of the present disclosure provides a method for assembling a battery pack. The method includes: a) providing a battery housing with an interior space and a plurality of crossbeams, a plurality of cell units, a plurality of spacers, and a plurality of venting devices; b) arranging the plurality of crossbeams to divide the interior space of the battery housing into a plurality of separated accommodation chambers; and c) arranging the plurality of cell units, the spacers, and the venting devices within the battery housing. Each of the cell units includes a plurality of stacked battery cells, and each of the accommodation chambers accommodates at least two of the plurality of cell units separated by the at least one spacer stacked between the at least two cell units. The plurality of crossbeams and the plurality of cell units are arranged such that at least one venting path is provided per cell unit, and each venting path connects the respective cell unit with a respective venting device of the corresponding accommodation chamber without passing an adjacent cell unit. The method may include steps to assemble a battery pack including any of the aforementioned features in any suitable combination to achieve the aspects and features associated therewith.

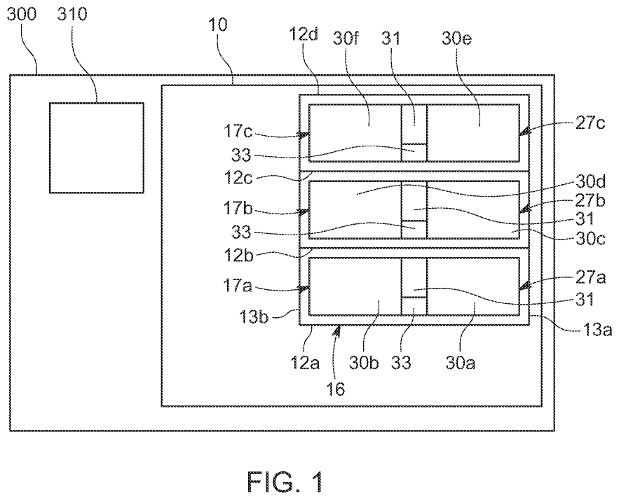

FIG. 1 is a schematic view of a vehicle 300 according to an embodiment.

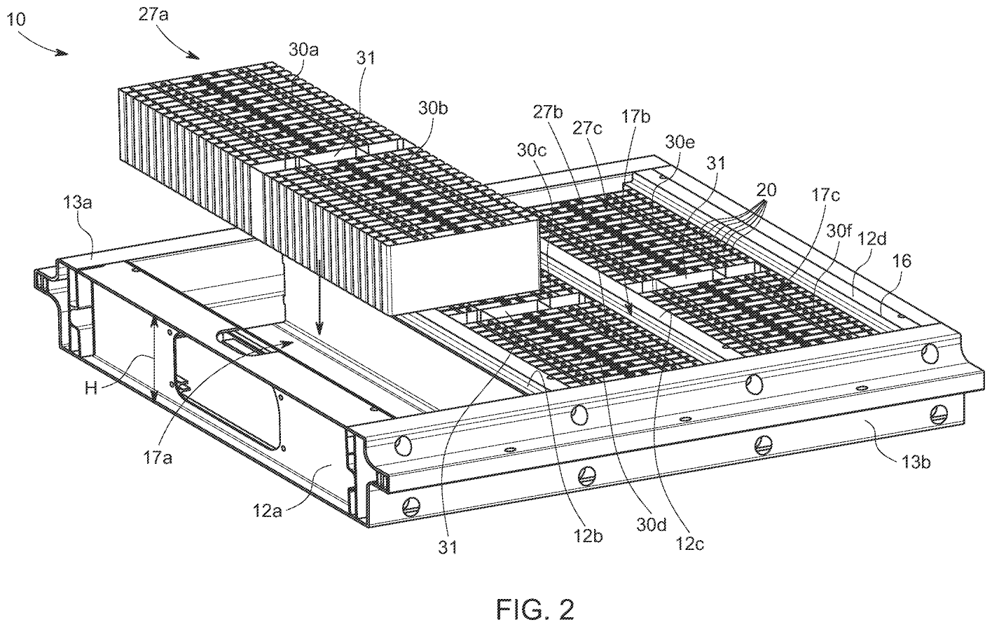

The vehicle 300 is propelled by an electric motor 310 using energy stored in rechargeable batteries cells 20 (see, e.g., FIGS. 2 to 6) arranged in a battery pack 10. The battery cells 20 are arranged in a stacked (or aligned) manner in cell stacks 27a, 27b, 27c.

FIG. 2 is a perspective view of a battery pack 10 according to an embodiment.

The battery pack 10 includes a battery housing 16 providing an interior space and including a plurality of crossbeams 12a, 12b, 12c, 12d dividing the interior space of the battery housing 16 into a plurality of separated accommodation chambers 17a, 17b, 17c.

The battery pack 10 includes (or accommodates) cell stacks 27a, 27b, 27c. Each of the cell stacks 27a, 27b, 27c is arranged in one of the accommodation chambers 17a, 17b, 17c. For example, the cell stack 27a is retained in the accommodation chamber 17a as indicated by the arrow pointing from the cell stack 27a to the accommodation chamber 17a. Each of the cell stacks 27a, 27b, 27c includes a plurality of (e.g., two) cell units 30a, 30b, . . . , 30f. The battery pack 10 includes a plurality of spacers 31. Each of the cell stacks 27a, 27b, 27c includes one of the plurality of spacers 31 arranged between the cell units 30a, 30b, . . . , 30f in the respective cell stack 27a, 27b, 27c.

Thus, battery pack 10 includes the plurality of cell units 30a, 30b, . . . , 30f arranged within the battery housing 16. Each of the cell units 30a, 30b, . . . , 30f includes a plurality of stacked battery cells 20 (e.g., prismatic battery cells). Each of the accommodation chambers 17a, 17b, 17c accommodates at least two (e.g., a plurality) of the cell units 30a, 30b, . . . , 30f, and the cell units 30a, 30b, . . . , 30f are separated by one of the spacers 31 stacked between the adjacent cell units 30a, 30b, . . . , 30f within one of the accommodation chambers 17a, 17b, 17c.

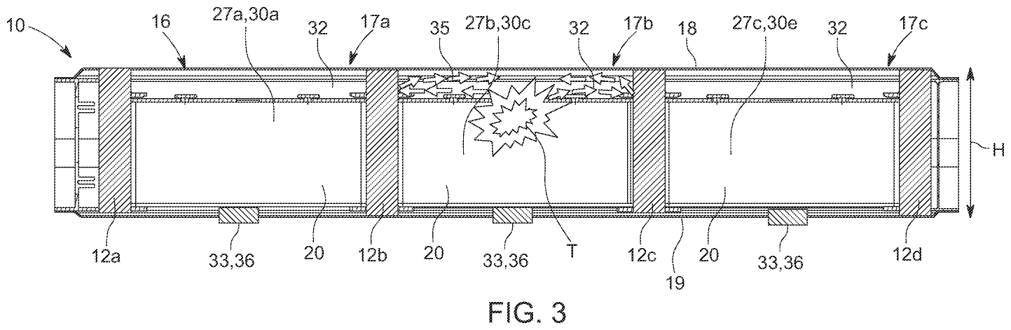

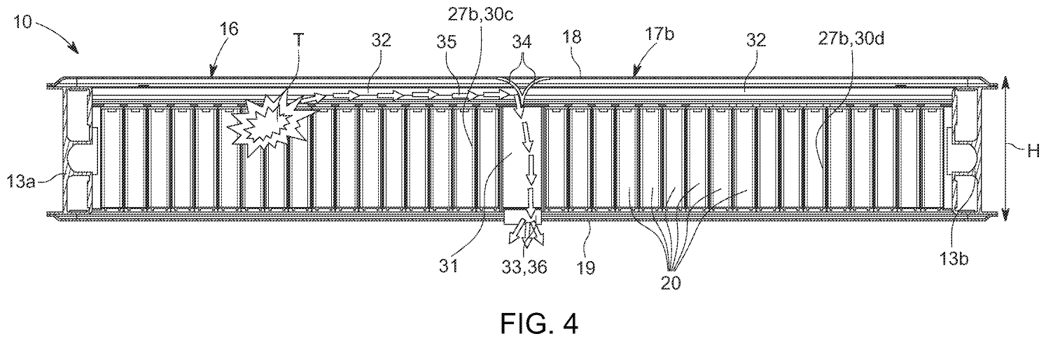

The battery pack 10 includes at least one venting path 32 (see, e.g., FIGS. 3 and 4) per cell unit 30a, 30b, . . . , 30f and a venting device 33 (see, e.g., FIGS. 3 and 4) for each of the accommodation chambers 17a, 17b, 17c. Each venting path 32 connects the respective cell unit 30a, 30b, . . . , 30d with a respective venting device 33 of the corresponding accommodation chamber 17a, 17b, 17c without passing (e.g., without fluidly communicating with) an adjacent cell unit 30a, 30b, . . . , 30d.

The battery pack 10 includes three rows of cell stacks 27a, 27b, 27c in the illustrated embodiment, but the present disclosure is not limited to three rows of cell stacks. To provide structural support for the battery pack 10 and for retaining the cell stacks 27a, 27b, 27c, the battery pack 10 includes a plurality of (e.g., two) longitudinal beams 13a, 13b and a plurality of (e.g., four) crossbeams 12a, 12b, 12c, 12d arranged between and connected to the longitudinal beams 13a, 13b.

The crossbeams 12a, 12b, 12c, 12d are arranged in parallel to each other, and the plurality of crossbeams 12a, 12b, 12c, 12d includes two outer crossbeams 12a, 12d and, in the illustrated embodiment, two inner crossbeam 12b, 12c. In other embodiments, however, a battery pack may include a different number of crossbeams and/or differently-sized longitudinal beams to provide a differently sized battery pack.

The cell stacks 27a, 27b, 27c and the crossbeams 12b, 12c are alternately stacked between the two outer crossbeams 12a, 12d. Thus, the accommodation chambers 17a, 17b, 17c to retain the cell stacks 27a, 27b, 27c are provided between any neighboring pair of crossbeams 12a, 12b, 12c, 12d.

The length of each of the crossbeams 12a, 12b, 12c, 12d in an elongation direction from one of the longitudinal beams 13a to the other longitudinal beam 13b matches (e.g., is the same or substantially the same as) the length of the cell stacks 27a, 27b, 27c so that cell stacks 27a, 27b, 27c can be arranged and retained between the pairs of crossbeams 12a, 12b, 12c, 12d.

A lateral extension of each of the crossbeams 12a, 12b, 12c, 12d matches a lateral extension of the battery housing 16. For example, a height H of the crossbeams 12a, 12b, 12c, 12d reaches from a bottom cover 19 (see, e.g., FIGS. 3 and 4) of the battery housing 16 to a top cover 18 (see, e.g., FIGS. 3 and 4) of the battery housing 16 to match the height H of the battery housing 16. The accommodation chambers 17a, 17b, 17c and, thus, the cell stacks 27a, 27b, 27c are therefore separated from each other by the crossbeams 12a, 12b, 12c, 12d so that no vent gas 35 can flow from one of the accommodation chambers 17a, 17b, 17c to another of the accommodation chambers 17a, 17b, 17c or so that the flow of vent gas 35 from one of the accommodation chambers 17a, 17b, 17c to another of the accommodation chambers 17a, 17b, 17c is negligible.

The two longitudinal beams 13a, 13b are arranged in parallel to each other, and each of the two longitudinal beams 13a, 13b is elongated along a first extension direction. The crossbeams 12a, 12b, 12c, 12d are arranged in parallel to each other, and each of the crossbeams 12a, 12b, 12c, 12d is elongated along a second extension direction. The first and second extension directions may be perpendicular to each other. For example, in one embodiment, the crossbeams 12a, 12b, 12c, 12d and the two longitudinal beams 13a, 13b are arranged perpendicular to each other. Thus, accommodation chambers 17a, 17b, 17c having rectangular cross-sections are formed in the battery pack 10 to retain the cell stacks 27a, 27b, 27c.

Each of the crossbeams 12a, 12b, 12c, 12d is connected to the two longitudinal beams 13a, 13b by a plurality of fasteners extending, in the second extension direction, through the longitudinal beams 13a, 13b and into the crossbeams 12a, 12b, 12c, 12d. The longitudinal beams 13a, 13b have openings through which the fasteners extend into the crossbeams 12a, 12b, 12c, 12d.

The longitudinal beams 13a, 13b and the crossbeams 12a, 12b, 12c, 12d are, in one embodiment, extruded beams. The number of inner crossbeams 12b, 12c equals the number of cell stacks 27a, 27b, 27c minus one. Each of the cell stacks 27a, 27b, 27c is mounted between a pair of adjacent crossbeams 12a, 12b, 12c, 12d.

The battery housing 16 includes an interior separation member providing a collecting chamber within the battery housing 16, and each venting path 32 is arranged to extend into the collecting chamber. The battery housing 16 includes a duct member for fluid communication between the collecting chamber and an exterior of the battery pack 10.

FIG. 3 is a first sectional view of a battery pack 10 according to an embodiment. The first sectional view of the battery pack 10 shows a section of the battery pack 10 as described with reference to FIG. 2 along a cross-section in a plane perpendicular to the elongation direction of the crossbeams 12a, 12b, 12c, 12d.

In FIG. 3, a thermal event T is illustrated. For example, in FIG. 3, one of the battery cells 20 of the cell stack 27b, specifically of cell unit 30c, has reached a temperature so that a vent gas 35 leaves (or is emitted from) the battery cell 20. The vent gas 35 flows along a venting path 32 through the battery pack 10. The venting path 32 is arranged on top of the cell stack 27b and below the top cover 18 (e.g., the venting path 32 is formed between the cell stack 27b and the top cover 18).

As shown in FIG. 3, due to the crossbeams 12a, 12b, 12c, 12d, specifically, the inner crossbeams 12b, 12c in the illustrated situation, the vent gas 35 is kept in the accommodation chamber 17b in which the thermal event T has occurred and cannot leave the accommodation chamber 17b and flow into one of the adjacent accommodation chambers 17a, 17c. For example, due to the crossbeams 12b, 12c, the venting path 32 does not pass one of the adjacent cell units 30a, 30c in the adjacent accommodation chambers 17a, 17c. The venting path 32 connects the cell unit 30c via one of the spacers 31 with a respective venting device 33 of the corresponding accommodation chamber 17b without passing an adjacent cell unit 30a, 30b, 30d, 30e, 30f as described with reference to, for example, FIG. 4.

The battery pack 10 includes one venting path 32 per cell unit 30a, 30b, . . . , 30f and one venting device 33 for each of the accommodation chambers 17a, 17b, 17c. Each venting path 32 connects the respective cell unit 30a, 30b, . . . , 30d with a respective venting device 33 of the corresponding accommodation chamber 17a, 17b, 17c without passing an adjacent cell unit 30a, 30b, . . . , 30d. The venting devices 33 are arranged in the bottom cover 19 of the battery housing 16.

Each of the accommodation chambers 17a, 17b, 17c includes one venting device 33 per cell stack 27a, 27b, 27c; for example, each of the cell units 30a, 30b, . . . , 30f is connected with one of the venting devices 33 via a venting path 32.

Each of the venting devices 33 includes a burst membrane 36 configured to burst when a pressure within one of the accommodation chambers 17a, 17b, 17c exceeds a reference pressure (e.g., a predetermined pressure).

FIG. 4 illustrates a second sectional view of a battery pack 10 according to an embodiment. The second sectional view of the battery pack 10 shows a section of the battery pack 10 as described with reference to FIGS. 2 and 3 across a cross-section in a plane perpendicular to the elongation direction of the longitudinal beams 13a, 13b, that is, perpendicular to the elongation direction of the crossbeams 12a, 12b, 12c, 12d. FIG. 4 shows the thermal event T in one of the cell units 30c as explained with reference to FIG. 3.

The venting device 33 is arranged below the spacer 31 of the cell stack 27b and at the bottom cover 19 of the battery housing 16. Thus, the venting device 33 of the cell units 30c, 30d of the cell stack 27b in the accommodation chamber 17b is arranged below the corresponding spacer 31 between the cell units 30c, 30d. For example, each of the cell stacks 27a, 27b, 27b includes one venting device 33 that is arranged below the respective spacer 31 between the cell units 30a, 30b, . . . , 30f of the respective cell stack 27a, 27b, 27c.

The venting path 32 is provided (or formed) on top of the cell stack 27b, specifically of the cell unit 30c in the figure, and extends over any of the battery cells 20 of the cell unit 30c. Thus, a vent gas 35 from any of the battery cell 20 of the cell unit 30c can flow from the battery cell 20 along the venting path 32 through the spacer 31 to the respective venting device 33 of the corresponding accommodation chamber 17b.

The battery pack 10 includes a vent gas guide 34. The vent gas guide 34 includes a plurality of (e.g., two) sheet metal portions arranged and fixed to the top cover 18. The vent gas guide 34 is configured to direct vent gas 35 of one of the cell units 30a, 30b, . . . , 30f to the respective venting device 33 via the venting path 32 through the spacer 31. During the thermal event T, the vent gas guide 34 directs the vent gas 35 from the battery cells 20 of the cell unit 30c to the venting device 33. The vent gas guide 34 is arranged at the top cover 18 of the battery housing 16 and opposite to the venting device 33. Thus, the vent gas guide 34 is arranged above the spacer 31.

The venting device 33 is arranged within the spacer 31 that separates the cell units 30c, 30d of the cell stack 27b in the accommodation chamber 17b from each other. Thus, the venting path 32 connects the respective cell unit 30c with the venting device 33 of the corresponding accommodation chamber 17b without passing an adjacent cell unit 30d within the same accommodation chamber 17b. As described above with reference to FIG. 3, the venting path 32 is arranged such that the vent gas 35 cannot pass an adjacent accommodation chamber 17a, 17c. Thus, the venting path 32 connects the respective cell unit 30b with the venting device 33 of the corresponding accommodation chamber 17b without passing any of the adjacent cell units 30a, 30d, 30e arranged within any of the adjacent accommodation chambers 17a, 17c.

Due to the arrangement of the venting path 32 on top of the cell stack 27b, the venting path 32 of the adjacent cell units 30c, 30d within the same accommodation chamber 17b extends through the spacer 31 stacked between the adjacent cell units 30c, 30d. The venting path 32 of two adjacent cell units 30c, 30d within the same accommodation chamber 17b extend through the spacer 31 stacked between the two adjacent cell units 30c, 30d.

The venting paths 32 of the adjacent cell units 30c, 30d do not overlap until the venting paths 32 reach the spacer 31 due to the vent gas guide 34.

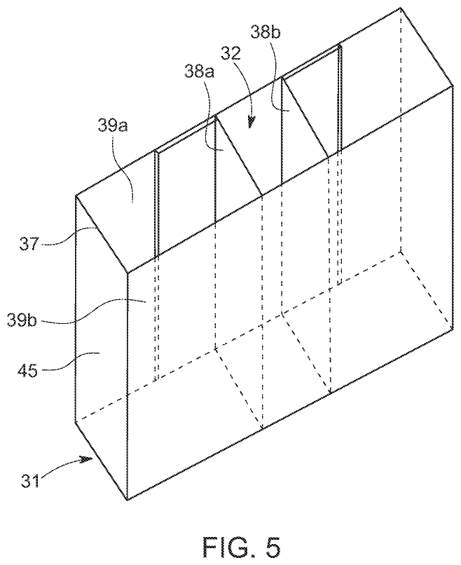

FIG. 5 illustrates a perspective view of a spacer 31. The spacer 31 is an embodiment of the spacer 31 of the battery pack 10 described above.

The spacer 31 includes a spacer frame 37. For example, the spacer frame 37 may be made of sheet metal.

The spacer 31 has two longitudinal side surfaces 39a, 39b and two narrow side surfaces 45. The area of each of the longitudinal side surfaces 39a, 39b is larger than the area of the two narrow side surfaces 45, only one of which is indicated in FIG. 5. The longitudinal side surfaces 39a, 39b are parallel to each other. In each of the cell stacks 27a, 27b, 27c as shown in, for example, FIGS. 2 to 6, each of the longitudinal side surfaces 39a, 39b of the spacer 31 contacts one of the battery cells 20 of the cell stacks 27a, 27b, 27c.

The spacer 31 includes two vent gas duct members 38a, 38b. Each of the vent gas duct members 38a, 38b is attached by, for example, welding, clamping, and/or gluing, to one of the longitudinal side surfaces 39a. Each of the vent gas duct members 38a, 38b extends from one of the longitudinal side surfaces 39a to the other longitudinal side surface 39b so that a part of the venting path 32 is formed between and constraint by the vent gas duct members 38a, 38b and the longitudinal side surfaces 39a, 39b.

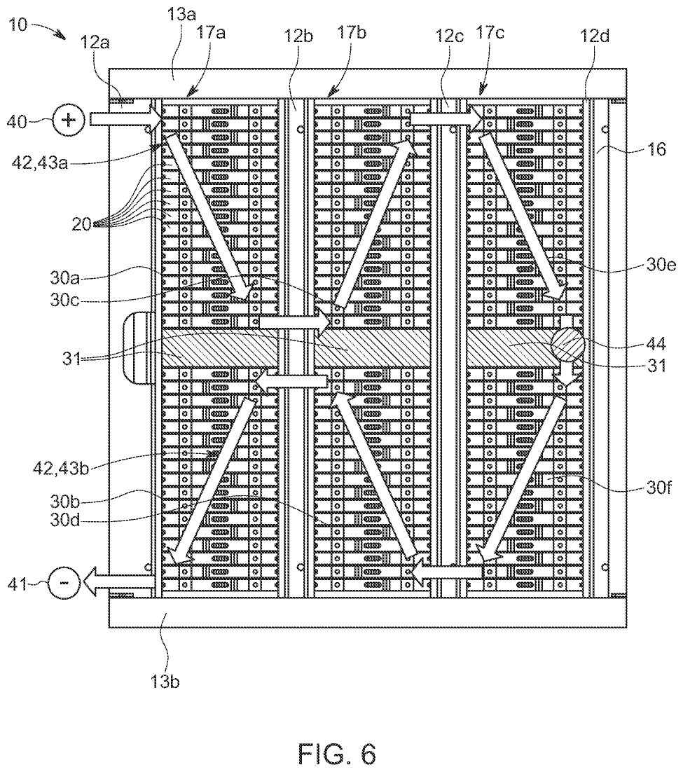

FIG. 6 illustrates a schematic top view of a battery pack 10 according to an embodiment. The battery pack 10 as shown in FIG. 6 is the battery pack 10 as described above with reference to FIGS. 1 to 5. In this schematic top view, a series connection 42 and partial series connections 43a, 43b are indicated by double arrows with solid lines, and the direction of the arrows indicates the direction of an electric current flowing between a positive battery pack terminal 40 and a negative battery pack terminal 41.

The battery cells 20 of each of the cell units 30a, 30b, . . . , 30f are electrically connected in series as illustrated by the double arrows with solid lines. The cell units 30a, 30b, . . . , 30f are connected between the positive battery pack terminal 40 and the negative battery pack terminal 41 such that the cell units 30a, 30b, . . . , 30f are electrically connected in a series connection 42. For example, all the battery cells 20 of the battery pack 10 are, in the illustrated embodiment, connected in the series connection 42.

The series connection 42 includes two partial series connections 43a, 43b, each connecting a number of (e.g., more than one) cell units 30a, 30b, . . . , 30f in series. In this embodiment, each of the two partial series connections 43a, 43b electrically interconnects three cell units 30a, 30b, . . . , 30f. For example, one of the two partial series connections 43a electrically interconnects the cell units 30a, 30c, 30e in a series connection, and the other of the partial series connections 43b electrically interconnects the remaining cell units 30b, 30d, 30f in a series connection. Each of the partial series connections 43a, 43b connects cell units 30a, 30b, . . . , 30f arranged in different accommodation chambers 17a, 17b, 17c with each other. The partial series connection 43a connects cell units 30a, 30c, 30e, each of which is arranged in one of the accommodation chambers 17a, 17b, 17c, in series. The partial series connection 43b connects cell units 30b, 30d, 30f, each of which is arranged in one of the accommodation chambers 17a, 17b, 17c, in series. Any two cell units 30a, 30b, . . . , 30e of one of the partial series connections 43a, 43b are arranged in different accommodation chambers 17a, 17b, 17c.

The battery pack 10 includes a disconnecting member 44 selectively interconnecting the at least two partial series connections 43a, 43b. The battery pack 10 is configured to open the disconnecting member 44 in the event of a thermal runaway, a short between the positive battery pack terminal 40 and the negative battery pack terminal 41, and/or an accident of a vehicle 300 including the battery pack 10. This, and the separation of cell units 30a, 30b, . . . , 30f by the crossbeams 12a, 12b, 12c, 12d, ensure that, even in case of a thermal event T in which battery cells 20 are contaminated with electric conductive deposits, the voltage of the battery cells 20 within one of the accommodation chambers 17a, 17b, 17c and connected by one of the partial series connections 43a, 43b cannot be larger than the voltage of one of the cell units 30a, 30b, . . . , 30f. This reduces the risk of arcing by using, in this embodiment, only the disconnecting member 44. The disconnecting member 44 is arranged, and the partial series connections 43a, 43b is configured, such that the voltage of each of the partial series connections 43a, 43b equals the voltage of the battery cells 20 of three cell units 30a, 30b, . . . , 30e.

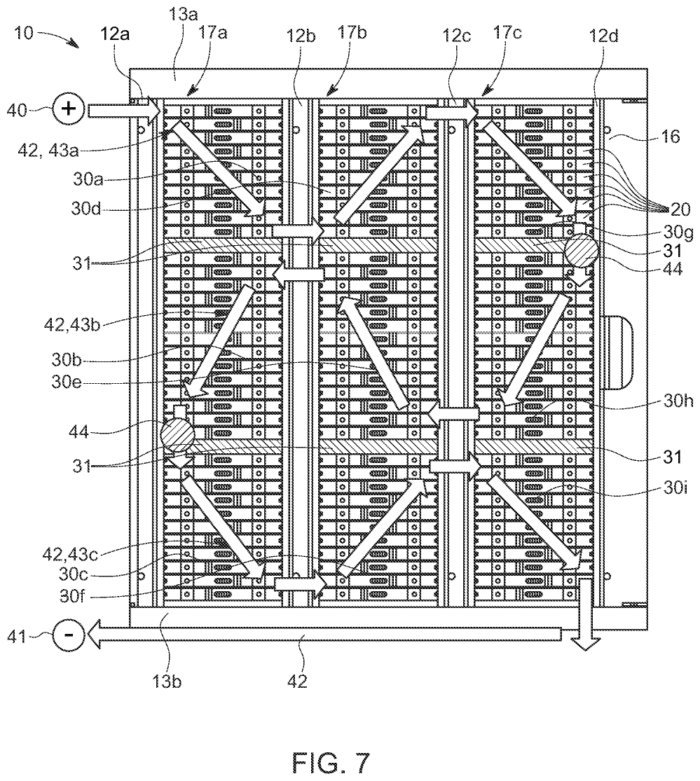

FIG. 7 illustrates a schematic top view of a battery pack 10 according to another embodiment. The embodiment of the battery pack 10 shown in FIG. 7 is described with reference to the embodiment of the battery pack 10 shown in FIGS. 1 to 6 with the differences between the embodiments of the battery packs 10 being primarily described. In this schematic top view, a series connection 42 and partial series connections 43a, 43b, 43c are indicated by double arrows with solid lines, and the direction of the arrows indicates the direction of an electric current flowing between a positive battery pack terminal 40 and a negative battery pack terminal 41.

Each of the cell stacks 27a, 27b, 27c includes three cell units 30a, 30b, . . . , 30i and two spacers 31, and one of the spacers 31 is arranged between any two cell units 30a, 30b, . . . , 30i in the same accommodation chamber 17a, 17b, 17c.

The series connection 42 includes three partial series connections 43a, 43b, 43c, each connecting a number of (e.g., more than one) cell units 30a, 30b, . . . , 30i in series. In this embodiment, each of the three partial series connections 43a, 43b, 43c electrically interconnects three cell units 30a, 30b, . . . , 30i. For example, one of the three partial series connections 43a electrically interconnects the cell units 30a, 30d, 30g in a series connection, the other of the partial series connections 43b electrically interconnects the cell units 30b, 30e, 30h in a series connection, and another of the partial series connections 43c electrically interconnects the remaining cell units 30c, 30f, 30i in a series connection. Each of the partial series connections 43a, 43b, 43c connects cell units 30a, 30b, . . . , 30i arranged in different accommodation chambers 17a, 17b, 17c with each other. The partial series connection 43a connects cell units 30a, 30d, 30g, each of which is arranged in one of the accommodation chambers 17a, 17b, 17c, in series. The partial series connection 43b connects cell units 30b, 30e, 30h, each of which is arranged in one of the accommodation chambers 17a, 17b, 17c, in series. The partial series connection 43c connects cell units 30c, 30f, 30i, each of which is arranged in one of the accommodation chambers 17a, 17b, 17c, in series. Any two cell units 30a, 30b, . . . , 30e of one of the partial series connections 43a, 43b, 43c are arranged in different accommodation chambers 17a, 17b, 17c.

The battery pack 10 includes two disconnecting member 44 selectively interconnecting the at least two partial series connections 43a, 43b, 43c. The battery pack 10 is configured to open the disconnecting member 44 in the event of a thermal runaway, a short between the positive battery pack terminal 40 and the negative battery pack terminal 41, and/or an accident of a vehicle 300 including the battery pack 10. This, and the separation of cell units 30a, 30b, . . . , 30i by the crossbeams 12a, 12b, 12c, 12d, ensure that, even in case of a thermal event T in which battery cells 20 are contaminated with electric conductive deposits, the voltage of the battery cells 20 within one of the accommodation chambers 17a, 17b, 17c connected by one of the partial series connections 43a, 43b, 43c cannot be larger than the voltage of one of the cell units 30a, 30b, . . . , 30i. This reduces the risk of arcing by using, in this embodiment, only two disconnecting members 44.

The disconnecting members 44 are arranged and the partial series connections 43a, 43b, 43c are configured so that the voltage of each of the partial series connections 43a, 43b, 43c equals the voltage of the battery cells 20 of three cell units 30a, 30b, . . . , 30i. For example, the number of disconnecting members 44 equals the number of cell units 30a, 30b, . . . , 30i divided by three minus one. The disconnecting members 44 are arranged in spacers 31 that are arranged in different accommodation chambers 17a, 17c, 17c.

Compared to an embodiment in which the partial series connections 43a, 43b, 43c are arranged per accommodation chamber 17a, 17b, 17c and providing disconnecting members 44 between the partial series connections 43a, 43b, 43c, the above-described arrangement improves safety performance because the crossbeams 12a, 12b, 12c, 12d provide a further reduction of a potentially safety-relevant voltage in case of a thermal event T. For example, if cell units 30a, 30b, . . . , 30i within one cell stack 27a, 27b, 27c per accommodation chamber 17a, 17b, 17c were connected in series with a partial series connection and adjacent cell stacks 27a, 27b, 27c were separated by a disconnection member 44, each of the partial series connection would lead to a voltage of three cell units 30a, 30b, . . . , 30i as described above. However, in case of a thermal event T in the middle cell unit 30e of the middle cell stack 27b, electrically conductive deposits could reach neighboring cell units 30d, 30f within the accommodation chamber 17b and lead to a voltage in the accommodation chamber 17b that equals the voltage of the battery cells 20 of the entire cell stack 27b. Thus, to achieve a voltage within each of the accommodation chambers 17a, 17b, 17c that is less or equal than the voltage of a cell unit 30a, 30b, . . . , 30i, six disconnection members 44 would be necessary because the cell units 30a, 30b, . . . , 30i within the same accommodation chambers 17a, 17b, 17c would need to be disconnectable from each other.

### SOME REFERENCE SIGNS

10 battery pack
12a, 12b, 12c, 12d crossbeam
13a, 13b longitudinal beam
16 battery housing
17a, 17b, 17c accommodation chambers
18 top cover
19 bottom cover
20 battery cell
27a, 27b, 27c cell stack
30a, 30b, . . . , 30i cell units
31 spacer
32 venting path
33 venting device
34 vent gas guide
35 vent gas
36 burst membrane
37 spacer frame
38a, 38b vent gas duct member
39a, 39b longitudinal side surface
40 positive battery pack terminal
41 negative battery pack terminal
42 series connection
43a, 43b, 43c partial series connection
44 disconnecting member
45 narrow side surface
300 vehicle
310 electric motor
H height
T thermal event

What is claimed is:

1. A battery pack comprising:
a battery housing comprising a plurality of crossbeams dividing an interior space of the battery housing into a plurality of separated accommodation chambers;
a plurality of cell units arranged within the battery housing, each of the cell units comprising a plurality of stacked battery cells, each of the accommodation chambers accommodating at least two of the cell units separated by a spacer stacked between the at least two cell units; and
a plurality of venting paths respectively arranged per each of the cell units, each of the venting paths connecting the respective cell unit with a respective venting device of the corresponding accommodation chamber without passing an adjacent one of the cell units.

2. The battery pack according to claim 1, wherein the cell units are connected between a positive battery pack terminal and a negative battery pack terminal such that the cell units are electrically connected in series, and
wherein the series connection comprises a plurality of partial series connections, each connecting a number of cell units to each other in series.

3. The battery pack according to claim 2, further comprising a disconnecting member configured to selectively interconnect the partial series connections.

4. The battery pack according to claim 3, wherein the battery pack is configured to open the disconnecting member in case of a thermal runaway, a short between the positive battery pack terminal and the negative battery pack terminal, and/or an accident of a vehicle comprising the battery pack.

5. The battery pack according to claim 2, wherein the cell units of each partial series connection are arranged in different accommodation chambers.

6. The battery pack according to claim 2, further comprising a vent gas guide configured to direct vent gas from one of the cell units to the respective venting device.

7. The battery pack according to claim 2, wherein each of the accommodation chambers comprises at least one of the venting devices per each cell unit.

8. The battery pack according to claim 7, wherein each of the venting devices comprises a burst membrane configured to burst when a pressure within one of the accommodation chambers exceeds a reference pressure.

9. The battery pack according to claim 1, wherein the battery cells of each of the cell units are electrically connected to each other in series.

10. The battery pack according to claim 1, wherein the venting paths of two adjacent ones of the cell units within the same accommodation chamber extend through the spacer stacked between the two adjacent ones of the cell units.

11. The battery pack according to claim 1, wherein a lateral extension of each of the crossbeams defines a lateral extension of the battery housing.

12. The battery pack according to claim 1, wherein the battery housing comprises an interior separation member forming a collecting chamber within the housing, and
wherein each of the venting paths is arranged to extend into the collecting chamber.

13. The battery pack according claim 12, wherein the battery housing comprises a duct member for fluid communication between the collecting chamber and an exterior of the battery pack.

14. A vehicle comprising the battery pack according to claim 1.

15. A method for assembling a battery pack, the method comprising:
providing a battery housing comprising a plurality of crossbeams defining an interior space, a plurality of cell units, a plurality of spacers, and a plurality of venting devices;
arranging the plurality of crossbeams to divide the interior space of the battery housing into a plurality of separated accommodation chambers; and
arranging the plurality of cell units, the spacers, and the venting devices within the battery housing,
wherein each of the cell units comprises a plurality of stacked battery cells,
wherein each of the accommodation chambers accommodates at least two of the cell units separated by the spacer stacked therebetween,
wherein the plurality of crossbeams and the plurality of cell units are arranged so that at least one venting path is provided per each of the cell units, and
wherein each of the venting paths connects the respective cell unit with a respective venting device of the corresponding accommodation chamber without passing an adjacent one of the cell units.
